(19) United States
(12) Patent Application Publication
(10) Pub. No.: US 2014/0365339 A1
(43) Pub. Date: Dec. 11, 2014

(54) Standardized, Commercial Real Estate "Lease Analysis Conversion and Comp Data" Platform

(71) Applicant: TenantRex, LLC, Baltimore, MD (US)

(72) Inventor: Adrian T. Hessen, Baltimore, MD (US)

(73) Assignee: TenantRex, LLC, Baltimore, MD (US)

(21) Appl. No.: 14/178,761

(22) Filed: Feb. 12, 2014

Related U.S. Application Data
(60) Provisional application No. 61/833,446, filed on Jun. 10, 2013.

(51) Int. Cl. G06Q 30/00; G06Q 30/06; G06Q 50/16

(52) U.S. Cl. CPC G06Q 30/0629; G06Q 50/16
USPC 705/26.64

(57) ABSTRACT

A method for providing service users with occupancy cost comparisons between a plurality of commercial leased properties includes the steps of: (a) defining an occupancy cost parameter for a leased property, (b) providing an interface for service users to input into a searchable database the identifying property information and the specific lease terms required to compute this occupancy cost parameter for each of the leased properties, (c) providing an algorithm that utilizes the inputted specific lease terms information to compute the occupancy cost parameter for each of the leased properties, (d) utilizing the occupancy cost parameters to create a fiduciary-responsibility-abiding (FRA) lease comp for each of the leased properties, and (e) storing in the database the FRA lease comp for each of the leased properties.

### CROSS-REFERENCE TO RELATED APPLICATION

This application claims the benefit of Provisional Patent Application No. 61/833,446, filed Jun. 10, 2013 by the present inventor. The teachings of this earlier application are incorporated herein by reference to the extent that they do not conflict with the teaching herein.

### BACKGROUND OF THE INVENTION

1. Field of the Invention

The present invention generally relates to data processing systems and methods. Specifically, the invention relates to a system and method for improving the usefulness and value of information databases for commercial real estate leases.

2. Description of the Related Art

There are many tools available to help commercial real estate rental brokers be successful in their profession. For example, a principal responsibility of such a broker is to help their tenant clients to value, evaluate and compare the alternative lease proposals that are being offered by landlords as a result of the broker showing the such clients various, “available” commercial rental spaces.

Since the formats for lease proposals may have many very different specific terms (e.g., some lease formats or types of leases prescribe various landlord operating expenses associated with a property that a tenant must pay, while others just fold these landlord expenses into an increased amount of basic rent that the tenant must pay), it is often a difficult task to evaluate the potential tenant occupancy costs of alternative lease proposals. Fortunately, there exist various pieces of “lease analysis” software that, assuming a broker can input into the software the costs prescribed by a lease's proposed terms and/or the subject property's historical or predicted operational costs, etc., are capable of analyzing and evaluating alternative leases and lease proposals so as to yield supposedly “apples to apples” comparisons and therefore allow one to see the true costs of these alternative lease proposals over their entire durations.

Such comparisons are part of what is often referred to as “occupancy cost analysis.” The objective of which is to compute a tenant's estimated total occupancy costs for the duration of a lease. Since the alternative properties being considered can differ in their size (ft²), the duration of the offered leases (# of years), the parameter most frequently used to denote this total cost is divided by the number of square feet being offered for leased and the number of years of the lease, so as to arrive at the tenant's average annual total occupancy cost per square foot (in units of annual dollar per square foot−$/(ft²−year)).” Such an “occupancy cost” calculation will typically also use the financial principal of net present values as applied to a time series of cash flows so as to apply a discount factor to the future expenses and therefore arrive at a “net occupancy cost.”

Thus, a prospective tenant tries to compare lease proposals applicable to alternative, being-considered-for-lease properties in terms of a single financial or tenant occupancy cost parameter for such competitive and presumably comparable properties. For occupancy cost comparison purposes, we refer herein to the result from applying lease analysis software to a lease proposal for a specific, being-considered-for-lease property as a “proposal occupancy cost,” which from a landlord's perspective is often expressed as a “net effective rent” value for a to-be-leased property.

Once a broker has characterized each of the various alternative lease proposals in terms of this single cost parameter or “proposal occupancy cost,” there is still more work to be done in order to help a client to understand their situation so that the client will be able to make a decision as to whether to accept one of the lease proposals. For example, the client will often want to know if the supposedly lowest “proposal occupancy cost” is actually a good deal in comparison to what his prospective neighbors and competitors are paying for their leases.

This is often a hard question for a broker to answer, since a prospective neighbor's or competitor's rental costs and lease terms are not matters which are publicly recorded—unlike the sale prices of commercial real estate. Thus, whereas a commercial real estate “sales” broker can always refer to a readily-available, public-records-based database of “sales comps” or the sales prices of nearby or comparable properties, the commercial real estate rental/lease broker does not have an equivalent database to try to draw upon to answer the client's question of whether an offered lease proposal is actually a “good deal.”

Individual brokerage firms will usually keep their own private databases of all the relevant deal information pertaining to each of the leases that they have handled for the properties that clients have leased or rented. The information in these databases goes by many names, such as “raw data,” “lease comp” data or just plain “comps”—as in “my client is considering a lease proposal for a space on the 20^{th} floor of building X and I need a “comp” for a space in the same building to be able to compare it to the proposal in order to assure my client that he'll be getting a good deal if he accepts this proposal.”

Examples of some of the elements that can be found in these “comps” include: base rent, escalation %, landlord operating expenses and concessions (e.g., months of free rent, tenant improvement allowance), tenant name and SIC code, lease structure and its dates of commencement and expiration, property address and size.

The confidentiality applied to this “lease comp” data can vary widely between brokerage firms that have such databases. For example, some brokerage firms will allow all their brokers access to all the information in its database, while other firms will allow a broker access to only the lease information on which that broker was a broker of record (i.e., represented either the tenant or the landlord in the lease transaction).

Thus, if the broker seeking a “comp” in building X happens to be with a brokerage firm that allows brokers access to all the lease information in the firm's database, and if the firm happens to have been involved in another building X lease transaction, then such a broker should have relatively easy access to a “comp” for building X. But, if a broker is not in a firm that has a building X comp and shares the lease information in its database with all of its brokers, the task of obtaining the desired building X “comp” is usually extremely difficult.

This situation is due to the fact that it is the norm for most commercial real estate brokerage firms to closely guard and protect from dissemination to non-firm members the information in their databases of lease transaction information. There are two key reasons for this norm.

First, it is widely believed that such outside information dissemination can have a significant negative impact upon a brokerage firm's earnings. For example, if a competing broker acquires specific “comp” information about a tenant (e.g., a tenant's lease expiration data), this acquiring broker is more likely to be able to provide services to such a tenant and therefore convert the acquired information into a commission at the expense presumably of the firm that had previously provided service to this tenant and therefore had a “comp” for this earlier transaction in the firm's database.

Second, such “lease comp” data has statutory confidentiality imposed upon it—i.e., in most states, brokers are licensed to practice commercial real estate and have a fiduciary responsibility to their clients. Therefore, a broker cannot, without the client's permission, communicate to others, for example, the specific terms of a client's lease (i.e., the contents of a “comp”) or the broker's confidential communications with the client during a lease negotiation process.

There are some subscription service, web-based, commercial real estate lease databases that provide information regarding individual leased properties or buildings. However, the extent of the information in these databases is reportedly often very limited. For example, some of these databases identify leased properties by their addresses, and include additional information such as the name of the property's tenant and the size of the property, etc.—usually missing from this data is information regarding the financial aspects of the listed properties' applicable leases.

The internet-accessible database “compstak.com” purports to allow commercial real estate professionals to trade “lease comps” by inputting and withdrawing lease comps from its database. Those inputting such lease comps are assured that those who withdraw or use these inputted lease comps are never allowed to know the identity of the individual who actually inputted or submitted a comp. Such anonymity is reportedly for the purpose of addressing fiduciary responsibility concerns, but has also raised questions regarding the accuracy of this database's information.

There are also web-based, commercial real estate databases that provide information regarding the values for various operational cost elements of commercial rental buildings. These cost elements are some of the same information that is usually part of a leased property's “leased comp data” (e.g., a landlord's operating expenses, property taxes, utilities, janitorial expenses, management fees). When these building cost elements are divided by a building's total square footage of leased space (i.e., $/ft²), they should be equivalent to approximately the average value for these cost elements over all of the tenants in the building. To see examples of such databases, see www.trepp.com and www.boma.org.

Thus, despite the existence of many databases containing information pertinent to commercial real estate leases, this industry still needs more informative, privately-accessible-to-subscribing-service-users “lease comp” databases and a publicly-accessible, fiduciary-responsibility-abiding “lease comp” database which lists all or most of a geographic area's leased properties and provides enough information to allow a broker to answer the question of, for example, whether or not a client is getting a “good deal,” etc. in accepting a landlord's offered lease proposal.

### SUMMARY OF THE INVENTION

Recognizing the need for both more informative, privately-accessible-to-subscribing-service-users “lease comp” databases and a publicly-accessible-to-subscribing-service-users, fiduciary-responsibility-abiding (FRA) “lease comp” database to serve the commercial real estate industry, the present invention is generally directed to overcoming the problems and disadvantages exhibited by the existing methods and systems that are currently being used in the industry to, for example, answer the question of whether or not a client is getting a “good deal (if the client were to accept a landlord's lease proposal)” in comparison to the lease deals which a prospective tenant's proposed new neighbors or competitors are currently getting. As disclosed herein, this can be accomplished by the creation a database containing the occupancy costs for individual leased properties in various geographic marketplaces.

The present invention discloses and enables a service provider to operate a subscription, cloud based, service in which participating commercial real estate brokerage firms or brokers directly upload their proprietary “lease comp” data (i.e., “all the relevant deal information pertaining to the leases which they have handled for their client's properties) and any “market comp” data that they have acquired into their very own, centralized database that is provided by the service provider. Specialized algorithms are then used to translate and convert this incoming raw data into an industry-standard metric of a property's occupancy cost, or into “standardized lease comps (SLCs).”

The present invention enables a participating brokerage firm or service user to confidentially and readily share these SLCs throughout its own organization. Such sharing has the benefit of creating access to this occupancy cost metric for a greater number of leased properties in specified geographic areas and thereby provides for all service users a much more accurate baseline of the occupancy cost in their leasing marketplaces.

According to a preferred variant of the present invention, a method for providing service users with occupancy cost comparisons between a plurality of commercial leased properties includes the steps of: (a) defining an occupancy cost parameter for a leased property, (b) providing a database, (c) providing an interface for each of the service users to input into the database the identifying property information and the specific lease terms required to compute the occupancy cost parameter for each of the leased properties to which a service user has been a principal in the leasing transaction of the leased property, (d) providing an algorithm that utilizes the inputted specific lease terms information to compute the occupancy cost parameter for each of the leased properties, (e) utilizing the computed occupancy cost parameters to create a fiduciary-responsibility-abiding (FRA) lease comp for each of the leased properties, (f) storing in the database the FRA lease comp for each of the leased properties, and (g) wherein the database having a configuration adapted to provide for the searching of the created FRA lease comps stored in the database by each of the service users.

Thus, there has been summarized above (rather broadly and understanding that there are other preferred embodiments which have not been summarized above) the present invention in order that the detailed description that follows may be better understood and appreciated.

### BRIEF DESCRIPTION OF THE DRAWINGS

FIG. 1 is a block diagram illustrating the general architecture and elements of the present invention.

FIG. 2 is a listing of the various pieces of information that can be included in raw or lease comp data.

FIG. 3 is an example of the website of the present invention's dashboard page or a screen shot for its initial search-by-address page.

FIG. 4 is an example of a screen shot that illustrates the type of search results provided a search-by-address search conducted by the present invention.

FIG. 5 is an example of a screen shot that illustrates how the present invention has the ability to use its database to initiate the creation of various analytical reports on the commercial real estate market.

FIG. 6 is an example of a screen shot that illustrates one of the analytical reports that can be created by the present invention.

### DESCRIPTION OF THE PREFERRED EMBODIMENT

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The present invention generally relates to, among other things, an improved method or system for providing more useful, comparative cost information (e.g., the occupancy costs for individual properties in various geographic areas) to the commercial real estate market. However, before one can begin to disclose the present invention in detail, one has to provide more background information for this marketplace and the commercial real estate leasing process so that the challenges to the creation of the present invention can be better understood.

A challenge to developing such an improved system of comparative leasing cost information is the fact that there are many types of commercial real estate leases. However, a basic understanding of such leases can be realized by one being familiar with the three major types of commercial real estate leases, they are:

(a) Full Service (FS) Lease—the quoted lease rate for a prescribed rent period (e.g., $/month) includes a base rent rate (which will typically be quoted to increase annually by a prescribed percentage—i.e., an escalation) and all of the landlord's operating costs or expenses (e.g., property or real estate taxes, building insurance, common area maintenance expenses, property management fees), up to and including janitorial service and utilities (power, water, garbage collection; though not phone and data service), with the landlord generally having the right to pass through to the tenant any future increases in these expenses. This form of lease is often considered to be the most simple and straightforward type of lease from the tenant's perspective—i.e., a tenant's total occupancy cost is approximately just the quoted lease rate multiplied by the number of rent periods specified by the leases' duration, plus the cost of any expense increases;

(b) Net Lease—(e.g., a Triple Net (NNN))—the tenant is quoted a base lease rate and a “pass-through” or “net” expense rate which includes some of the landlord's estimated fiscal year expenses incurred in operating the building, which the tenant is required to pay to the landlord (typically on a monthly basis, with reconciliation at year-end) in addition to the quoted base lease rate. In a Triple Net or NNN lease, the tenant pays for the three broad categories of operating expenses: property taxes, building insurance and utilities, with maintenance and property management fees also generally being rolled into these “carve-outs.” The Net lease is the standard for freestanding buildings and corporate campuses, and is becoming increasingly prevalent in multi-tenant buildings as well.

(c) Modified Gross (MG) Lease—the quoted lease rate generally includes the building's property taxes, insurance and maintenance expenses, but not its utilities. It is more commonly used for a building where individual tenant suites are separately metered and the tenants must contract for, with the suppliers, and pay directly their own utility bills.

From the definitions of these three major types of commercial real estate leases, one sees that the actual language or specific terms of these leases will typically not directly specify a landlord's operating costs or a lease's “pass-though” expenses, and therefore will not specify all of the elements that a tenant needs in order to be able to calculate a tenant's total occupancy cost over the duration of the lease. Thus, one concludes that just access to a leased property's applicable lease alone, assuming that such access could be achieved without violating a broker's fiduciary responsibilities, will not provide all of a property's occupancy cost information that the present invention aspires to include in a standardized format in the new database which the present invention seeks to create.

To consider how this information might be acquired, it is instructive to consider the various steps, and their timing or duration, in a typical commercial real estate leasing transaction. These typically are: (1) a client hires a commercial real estate rental broker, (2) the client & broker tour prospective rental spaces and buildings, (3) the client selects a short list of possibly desirable spaces for which landlord rental proposals are requested, (4) the client receives various types of landlord lease proposals (e.g., FS, NNN, MG) with specific offered lease terms, (5) a broker will typically need to take these lease proposals and put them into “lease analysis” software to get to an “apples to apples” comparison by which one can see and compare the true occupancy costs of the alternative lease proposals over the full durations of the leases (e.g., assuming that the terms of the lease proposals or other parts of the proposal provide values for all the software's required input variables, “lease analysis” software is used to compute a single cost parameter or metric for each of the being-considered-for-lease properties), (6) the client then usually selects a primary and a secondary choice among the offered proposals, (7) the client and broker negotiate a letter of intent to lease (LOI) with the selected landlord, thereby completing or agreeing to the business terms of the property's or space's rental, (8) these business terms are then put into a lease, (9) the tenant and landlord sign the lease, (10) the sometimes lengthy process of building out the space per the lease occurs, (11) the tenant moves into the leased space, (12) the broker submits an invoice for services rendered, and (13) usually only at the end of this process are a lease's terms duly recorded in a brokerage firm's confidential records, which today usually takes the form of a confidential, broker-accessible, electronic database of the terms of the lease transactions which the firm has handled.

Thus, by the time a lease's terms are recorded in such a firm's confidential database (e.g., 6-18 months after the lease terms were negotiated), many of the considerations (or data elements) that went into formulating these lease terms may not be readily-at-hand. This problem is compounded by the fact that all lease terms and the considerations that went into formulating them are not created equal—i.e., brokers are usually paid based only on the base rent of the lease and aren't therefore incentivized to keep all the data pertinent to a lease's other terms readily-at-hand.

Therefore, if one wants to create, for just a single brokerage firm, a database of the occupancy costs for the various commercial properties that the firm has leased in various geographic areas, one usually must begin by trying to find no longer readily-at-hand information (e.g., a landlord's expected operating costs, concessions) that is pertinent to a lease's agreed upon terms. This task is often made harder by the fact that the easiest-to-find, related information (e.g., the data that went into computing the occupancy cost for a proposed-to-be-leased property) is usually not an accurate reflection of the desired “lease comp” because any earlier computed occupancy cost will have been based on under-negotiation lease terms that will often have been subsequently amended in the final lease.

Even if all this needed background information pertinent to a brokerage firm's various lease transactions can be found, there still are significant problems to be overcome to allow one to successfully develop a desired database of the occupancy costs for commercial rental properties in various geographic areas. For example, unless a brokerage firm has a significant percentage of the leasing marketplace in a specified geographic area, the density of the leased properties in the area which can be called upon for occupancy cost comparative purposes will often be insufficient to allow one to make definitive property comparisons (i.e., there will be no comparable property in one's database with which a comparison can be made). Thus, there are indeed many significant hurdles to be overcome in creating an improved database for the commercial real estate marketplace that provides, for comparison purposes, the occupancy costs for individual leased properties in various geographic areas.

The present invention has overcome all of these problems by developing software that can be a broker's useful tool throughout the entire life cycle of a lease transaction (i.e., right from the conception of the lease in the lease analysis stage, through the multiple revisions in the negotiation stages, all the way to the final completed lease transaction), while also serving to create a “fiduciary-responsibility-abiding version of a lease comp (i.e., a FRA lease comp)” that can be used in a service-user-accessible database that will allow a broker to answer the question of whether or not a client is getting a “good deal” in accepting a landlord's offered lease proposal.

The typical “FRA lease comp” contains information pertaining to a specific leased property that is a matter of public record (e.g., a property's address, the tenant's name, the size of the leased area) and an occupancy cost parameter or the “standardized lease comp (SLC)” value for the property. Thus, such SLC values of all service users can be pooled together, without raising any confidentiality or fiduciary responsibility issues for a broker or service user, to create a database that has the potential of having listed within it a large percentage of the leased properties within any geographically defined marketplace of interest—i.e., a SLC database that makes possible property comparisons which will allow brokers or other paying subscribers to answer their clients “Am I getting a good deal” questions.

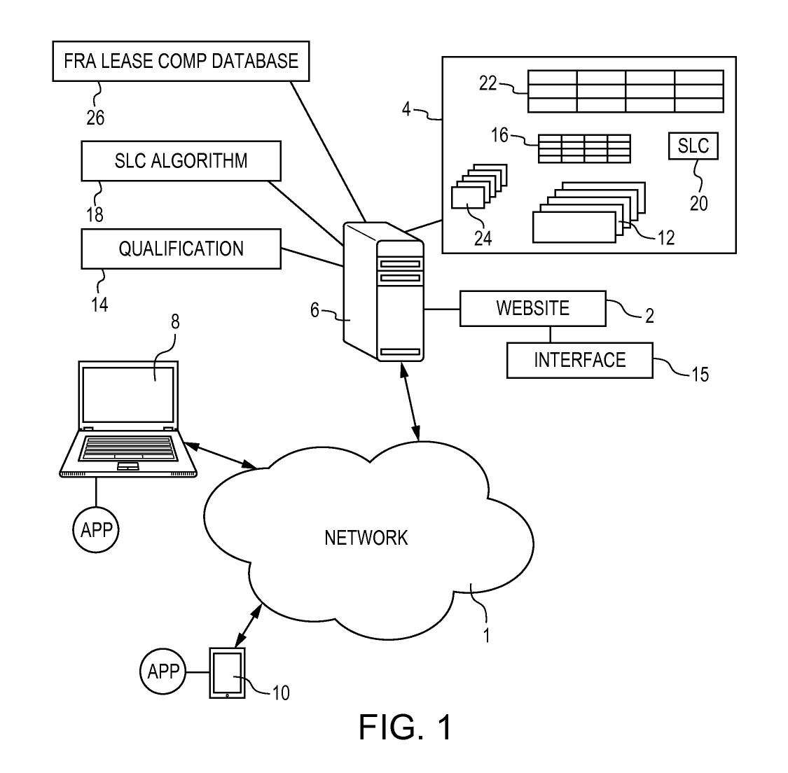

Since the databases of the present invention are dependent on brokerage firms and their brokers confidentially inputting information (i.e., “raw date” or “lease comp data”) regarding their lease transactions into these databases, the present invention is configured so as to make this data input task, as well as access to the database, as easy and convenient as possible. Thus, in a first variant of the present invention, access to a desired database is usually provided by a service provider who operates on a network 1, e.g., the internet, a website 2 that has sufficient non-transient, memory or data storage facilities 4 and computer processing capabilities 6 so as to perform the various tasks necessary for the service provider to offer improved commercial real estate informational and marketplace analysis services. The website is accessible by the register service users, i.e., individual brokers or brokerage firms, via a wide range of networked devices, such as portable computers 8, smart phones 10, etc. See FIG. 1.

The method of the present invention begins by creating and providing its service users with a spreadsheet or similar data input means 12 having data entry fields into which each of the service users list by address each of the properties for which the service user has been a principal party to the properties' lease transactions.

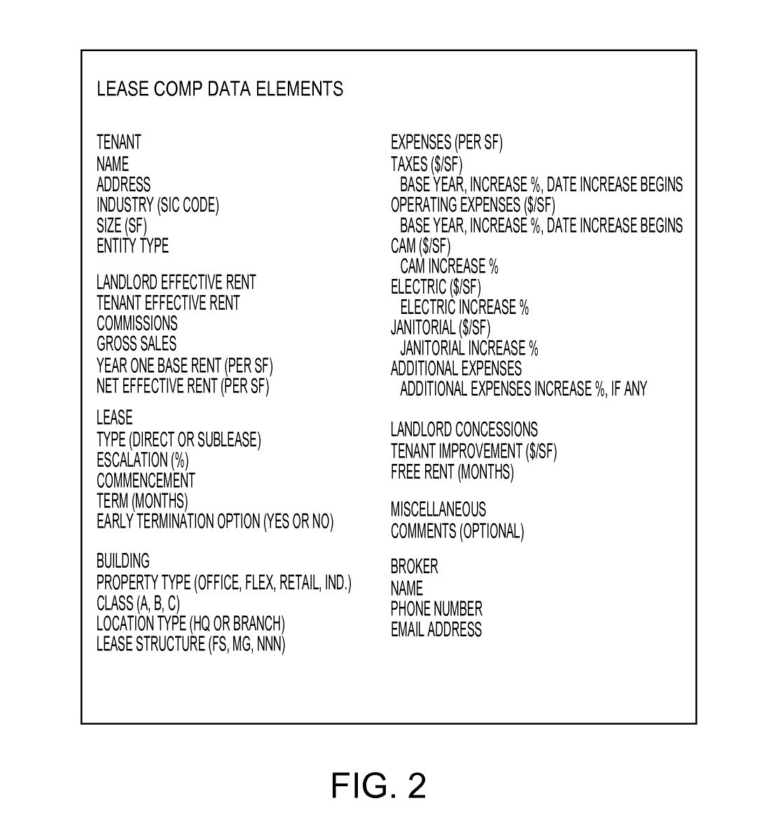

This is followed by inputting various information applicable to each of the properties, e.g., the name of the tenant of each of the properties, the specifics of each of the leases' terms (e.g., commencement date, expiration date, base rent, escalation %, landlord operating expenses and concessions [e.g., months of free rent, tenant improvement allowance], lease structure, property size), and various other information, which is often outside of the specific terms of a lease, that is helpful or required to compute a tenant's total occupancy costs over the full duration of the lease. See FIG. 2. Note should be taken that these spreadsheets are confidential to the service users who are entering data into them; however, this should not be taken to imply that all of the inputted information is confidential, since some of it is clearly in the public domain (e.g., for a leased property: it's address, the tenant's name, the size of the leased area (i.e., while not always directly available, it can often be easily estimated; e.g., a company X leases floors 8-11 of a 20 story building known to have 40 k square feet of leased space; thus, the size of X's leased area is approximately 4×40 k ft²/20=8 k ft²). The configuration of these spreadsheets or other data entry means have been adapted so as to make them especially easy for one to input into their data entry fields the values of the data that will be required to compute for a specific property a tenant's occupancy cost.

After each of the service users have listed on these spreadsheets each of the addresses of the properties pertinent to their lease transactions and the above-identified, lease information that is pertinent to them, the spreadsheets are collected through a specialized interface 15 of the present invention and then stored in each service user's own, confidential database. This data entry task is facilitated by the present invention's interface having a configuration adapted to allow it to be customized to a service user's special needs. For example, this configuration can allow for the utilization of a push-pull system that enables any data that is entered into a firm's existing database to be synced immediately with that service user's personal and confidential database within the present invention.

Service user inputted data is then reviewed by specialized portion of the software 14 of the present invention that runs on the website's supporting processors and performs the task of ensuring that all the data has been inputted which is required to enable an occupancy cost parameter or a “standardized lease comp (SLC)” value to be calculated for each the listed properties. However, we know from our prior discussion of the challenges encountered in trying to collect this needed information, that many of the listed properties will have a significant number of vacancies in the data entry fields whose values are needed for an occupancy cost or a “standardized lease comp” calculation.

The present invention resolves this problem by compiling a separate background or filler database or collection of tables 16 of average landlord operating costs, etc. for various geographic regions or areas. This background data is then used to provide “filler values” that go into the data entry fields for a property having vacancies in the fields required for the calculation of the tenant's occupancy cost, with a property's location relative to the background information's defined geographic regions determining which of this data's many possible, geographic-region-appropriate “filler values” are inputted for a specific property.

Once the spreadsheets have the necessary filler values inputted, a “standardized lease comp” or occupancy cost parameter algorithm 18 is utilized by the website's supporting computer processing capabilities 6 to calculate a “standardized lease comp” value 20 to characterize the occupancy cost for each of a service users' listed properties.

These “standardized lease comp” calculations are very similar to those for another occupancy cost parameter that is well known and widely understood in the commercial real estate industry—i.e., a property's “net effective rent” value. Depending upon whether a broker's client is a landlord or a tenant, it is often useful to express this occupancy cost parameter from either a landlord or a tenant's perspective. Therefore, herein we refer to a tenant or landlord effective rent.

A “tenant effective rent (TER)” is defined as a tenant's true rent related to a certain lease transaction, based on the present value using the common discount rate, of all rent payable by a tenant over the initial fixed term, including any increase in operating expenses above a base year, operating expenses paid by the tenant, free rent periods and additional rent such as storage, parking. This rent also includes any upfront project costs such as information technology, furniture, fixtures and equipment, moving costs, architectural and engineering costs, and any tenant improvement allowance above that stated in the lease, with such remainder present values then amortized over the fixed initial lease term.

This “tenant effective rent” parameter seeks to establish the true present value of all cash or near cash outflows for a given lease deal. TER may be calculated as follows:
prepare a cash flow forecast showing contract rent payable broken out by month, quarter or year, as the case may be,
deduct the value of any free rent periods from rent calculated above,
add the value of total expenses, such as operating expenses, taxes, electric, insurance, janitorial, maintenance to the rent calculated above,
add the cost of any additional rent such as parking, storage or service charges,
add the cost of any tenant improvement costs above that of the lease allowance,
discount the rent to a present value using an annual discount rate, or the monthly or quarterly equivalent, and
amortize the present value in even amounts over the duration of the fixed lease term, excluding the term of optional renewals; generally, an annual per square foot rental rate is the desired resulting measurement unit for a TER.

A “market effective rent (MER)” is defined as the average TER for a specific boundary and filter and is calculated by adding together all the TERs and dividing by total number of properties identified within these boundary and filter constraints.

A “landlord effective rent (LER)” is defined a landlord's true rent received related to a certain lease transaction, based on the present value using the common discount rate, of all rent receivable by a landlord over the initial fixed term, including any increase in operating expenses above a base year, less the present value of all tenant improvements, free rent periods, operating expenses paid by the landlord, commissions payable, with such remainder present value then amortized over the fixed initial lease term.

This “landlord effective rent” parameter seeks to establish the true present value of all cash or near cash outflows for a given lease deal. LER may be calculated as follows:
prepare a cash flow forecast showing contract rent receivable broken out by month, quarter or year, as the case may be,
deduct the value of any free rent periods from rent calculated above,
add the value of total expenses paid by tenant due to landlord, such as operating expenses above a base year, taxes, insurance, janitorial, maintenance; do not include any expenses the tenant pays directly,
subtract any operating expenses paid by the landlord,
subtract any tenant improvement allowance,
subtract commissions,
discount the rent to a present value using an annual discount rate, or the monthly or quarterly equivalent, and
amortize the present value in even amounts over the duration of the fixed lease term, excluding the term of optional renewals; generally, an annual per square foot rental rate is the desired unit of measurement for a LER.

Such “standardized lease comp” values, whether in the form of a TER or LER, are then stored in a service user's database 22 within the website's data storage facilities. Only the service user inputting the data and its authorized personnel have access to these values and the rest of the inputted data; thereby, preserving the confidentiality of this information. The service user's database is configured so that it is searchable by using a wide range of search parameters, e.g., one can search a property's data according to parameters chosen from the group including the geographic location of the property, tenant name, building type, end point of lease, number of years remaining on the lease, broker name, landlord name, etc.

In order to create a database capable of giving one the most reliable view of a particular geographic area of a rental marketplace, it is advisable that one create a database with as high a density of listed properties per unit geographic area as possible. This desire to achieve a high density of listed properties is aided by the fact that there is often, via local news publications, broker press releases and various broker publications, information on specific rental properties that is public knowledge.

To capture this “market” information in a database, a similar, proprietary “market” spreadsheet or other data input means 24 is utilized to allow a service user to input such public knowledge information regarding a leased property. Like the standard spreadsheets 12, these “market” spreadsheets are then collected, and for each of the listed “market” properties (i.e., properties for which the service user inputter was not a principal in the lease transaction for the property), the spreadsheets' vacancies are filled with the appropriate “filler values,” “tenant effective rents” are computed for each of these “market” properties, and then all of this information is stored in the service user's database. If these properties are identified in the search of the database, they are distinguished from “regular” properties (where the data inputter was a principal in the lease transaction for the property) by denoting them as “market” properties and we refer to the data pertaining to such properties as “market comps.”

The configuration of this database is such that its service user can regulate how much information pertaining to each lease comp is actually viewable by those who have authorization to access the database. For example, a broker can allow other fellow brokers in his or her firm access to the broker's entire collection of data for one or specific listed properties. Alternatively, a broker can provide only limited access—e.g., to an occupancy cost parameter or “standardized lease comp (SLC)” value that is computed by the present invention for a specific property and the property's public information data (e.g., property address, name of tenant, size of property, etc.). If the service user is a brokerage firm, it can provide access to its database to all of its brokers. Depending on the number of offices or brokers in the firm, this can lead to these brokers having access to a huge number of listed properties and possibly adequate property density listings to enable reasonable property comparisons to be made for a great many geographically defined marketplaces of interest.

For those situations in which a service user's database does not have adequate property density listings to enable reasonable property comparisons to be made in a geographically defined marketplace of interest, the present invention provides, as previously mentioned, a means for addressing such situations—i.e., a “FRA lease comp.”

The contents of this “FRA lease comp” is such that it can be shared with others without calling into question or contributing to a service user violating any responsibilities to their clients and the confidentiality of any lease comp data. Thus, a typical “FRA lease comp” might, for example, contain the information pertaining to specific leased properties that is a matter of public record (e.g., a property's address, the tenant's name, the size of the leased area) and an occupancy cost parameter or the “standardized lease comp (SLC)” value that is calculated by the algorithms of the present invention. Such “FRA lease comp” data from all service users can be pooled together to create a “FRA lease comp” database 26 with adequate property density listings so as to enable reasonable property comparisons to be made in various geographically defined marketplaces of interest. To be clear, the publicly-available database of “FRA lease comps” will provide a way for paying subscribers to view rolled-up, aggregated data specific to building addresses or geographic boundaries but the data will not be identifiable to a specific lease comp, specific tenant or any other data element that would violate any responsibility to a brokers clients nor the confidentiality of the lease comp.

The present invention will contribute to creating a universal database of “FRA lease comps”—something akin to what the sales brokers have always had in terms of a “sales comps” database.

The system of the present invention, the preferred variant of which is referred to as TenantRex™, LeaseRex™ and MarketRex™ is in a preferred embodiment a network-based service that, among other things, securely facilitates the uploading of commercial real estate leasing data for the purpose of standardizing such data so that it can quickly and easily be used to allow brokers to better document the various aspects of their leasing efforts and understand the environments in which they are operating.

A preferred variant of the present invention generally works as follows: a user or subscriber logs into an interactive website that is created and operated by the software of the present invention. Once a user is granted access via the entering of a correct username and password, the user is directed to what is herein referred as the website's dashboard page or a screen shot for its home page which allows a service user to perform any one of a variety of actions or functions that a broker is generally required to perform in, for example: (i) helping a client to lease a desired office space, (ii) assisting the broker's firm in documenting this leasing process, and (iii) compiling a leasing process' pertinent information so that it can go into the firm's knowledge database that can be used to help their brokers provide the highest possible level of professional services to their clients.

These actions or functions can include: (a) after the client has gotten to the point in the leasing process that various lease proposals have been received from the landlords for the available-for-lease properties that the broker has shown the client, “lease analysis” of the various initial, landlord lease proposals so as to characterize each of them in terms of a single financial parameter or metric that is reflective of the tenant's total occupancy cost for the duration of each of the proposed lease—i.e., a single parameter that enables one to get to an “apples to apples” comparison by which one can see and compare the true occupancy costs of the alternative lease proposals over the full durations of each of the leases, (b) during the lease negotiation phase, calculation of the financial impact of various “what if” scenarios in terms of how the terms of a desired lease are actually constructed, (c) after a lease is signed, documentation of a signed lease's final terms and their impact on the client's actual, forecasted occupancy costs, (d) to contribute to the establishment of a more useful, knowledge database for the broker's firm, calculation of a “standardized lease comp” value to characterize the occupancy cost for the leased property, and (e) to help increase the property density listings to which a firm has access for lease comparison purposes, creation of “FRA lease comps.”

From this listing of functions, it can be seen that the present invention is intended for use at all points in a leasing process—i.e., throughout the life cycle of a lease transaction. In addition to being a multi-purpose tool for a broker, the present invention also serves a valuable purpose in helping a firm to better keep track of and document the various steps of its leasing transactions. As previously noted, improvements in this area have been noted as being greatly needed in many parts of the commercial real estate industry.

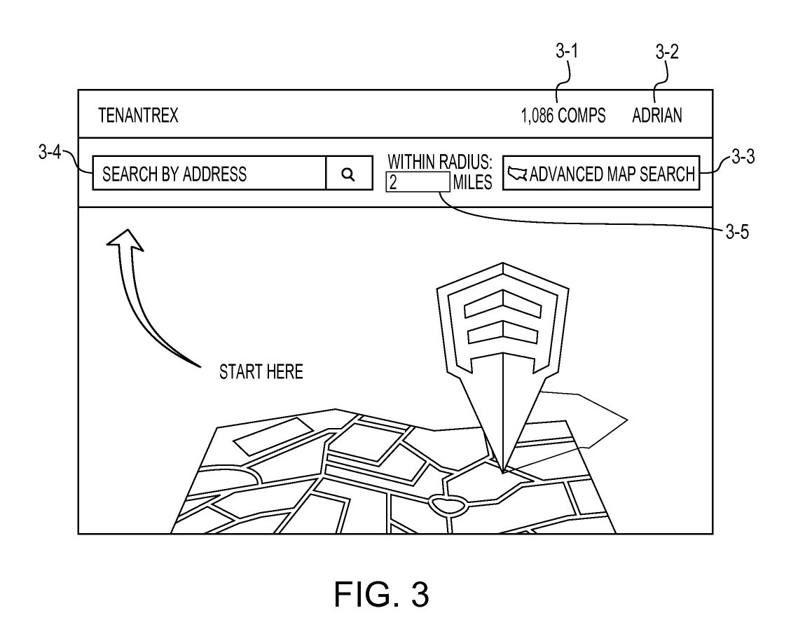

If a user of the present invention is at the point in a leasing process where he/she is trying to answer the question of whether or not a client is getting a “good deal,” etc. in accepting a landlord's offered lease proposal, an appropriate starting webpage for answering this question is shown in FIG. 3.

Shown there are: the number of “lease comps” or data points available to the user 3-1, the name of the user logged into the system 3-2, where to click for an advanced map search for properties within a specified geographic area 3-3, where to click to search this data by street address 3-4, and where to specify the size of an area around the desired address to be searched 3-5.

Upon clicking for an advanced map search, a new window or webpage opens allowing the user to select and draw specific geographic boundaries for the advanced search. As previously mentioned, a user may also search by a desired address or many other variables.

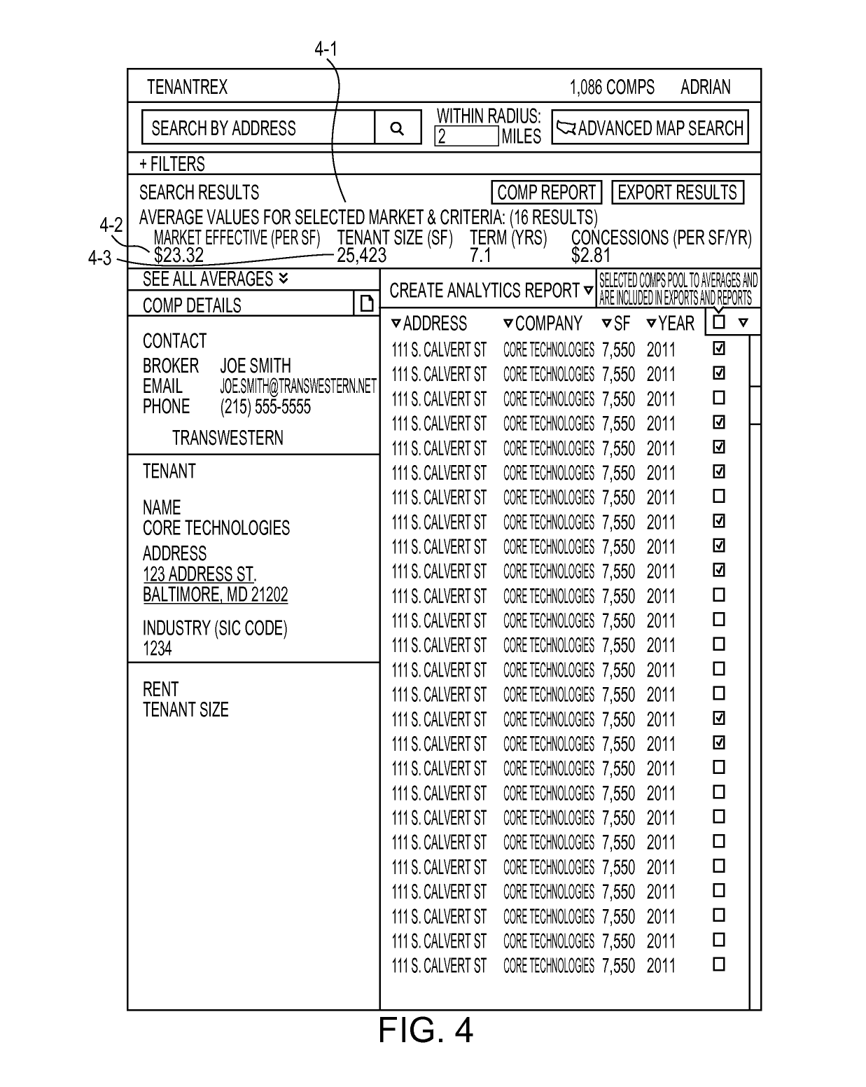

Once the user completes their search, the present invention creates another webpage that shows the search results. See FIG. 4. These search results, as previously noted, can takes many forms that contain only a few or many parameters, including, for example, the: number of “comps” returned or the number of properties found to lie in a designated geographic area, 4-1, the average over the number of returned “comps” of their standardized lease comp values, 4-2, and the tenant size in terms of the square footage of an identified tenant lease, 4-3.

The database and the interface of the present invention are configured to provide different views of one's search results. For example, the standard “comp” view means everyone internally (of the same firm) can view all of the data entry fields of the “comp.” A “confidential comp” view means only certain aspects or data entry fields of the “comp” can be viewed. Meanwhile, a “private comp” view means the broker has opted out of sharing anything with his/her firm co-workers.

By clicking on one of the listed search results in FIG. 4, a new screen shot opens that display the elements of a standard “comp” view. These will usually include: the brokerage firm's name, the broker's name, email address and phone number, the tenant's name, address and the nature of its business as revealed by its relevant SIC code, the property's size and its occupancy cost parameter or standardized lease comp. Additional information may also include: the lease type and its commencement date, any lease escalation specifics and whether or not the lease has an early termination option, the property's type, class, operating expense, the landlord's tenant improvement dollars and any months of “free” rent in order to allow the tenant to customize the space to their needs prior to the tenant actually moving into and occupying the space.

The configuration of the software of the present invention further includes various analytical algorithms that enable the present invention to perform a wide range of analytical tasks on the data that is stored in its databases. For example, in addition to having an algorithm for computing “standardized lease comp” values, the other algorithms of the present invention enable one to: (a) examine the various terms of the stored lease information so as to determine temporal trends or the variability of these terms within the tenants of specific buildings or for buildings lying within defined geographic boundaries, (b) compute the average and the standard deviation the tenant occupancy costs at a specific property address, (c) compute the average value of the concession packages provided at a specific property address, (d) compute the temporal trends in base rents or any other specific lease term within a property address or among a population of properties that are located within defined geographic boundaries, and (e) calculate the variability in the tenant effective rent of tenants that are located within defined geographic boundaries and who have the same SIC industry code.

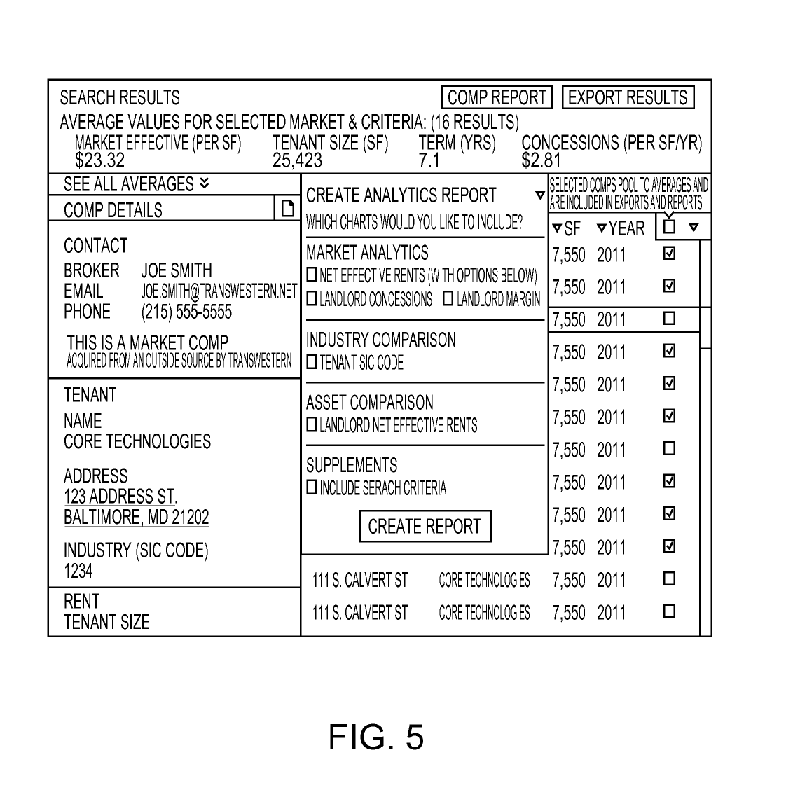

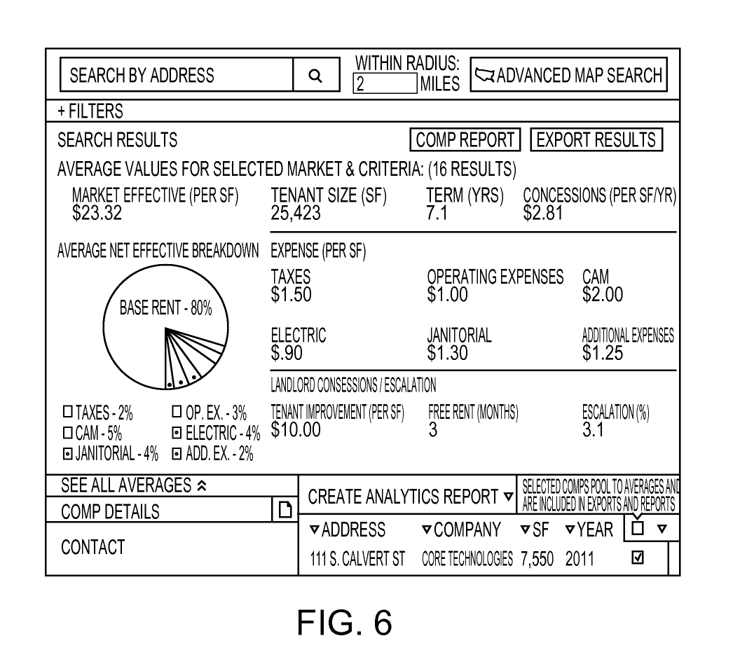

FIG. 5 is an example of a screen shot of the present invention that illustrates how one would go about initiating such a “landlord effective rent” and “landlord concessions” analysis by selecting the various properties to be analyzed and then creating a report documenting the results of such an analysis. See FIG. 6.

Should the user want to add search filters to the search results or begin the search by applying filters, the user can select a number of parameters by which to filter, including: lease type, property type, date range, location type, class, size and SIC codes. After the filters have been selected, the user can “apply filters” and the system will calculate or recalculate average values.

The present invention has an architectural design that can be customized per the subscriber's specification. For example, should a brokerage firm want to use a version of the present invention behind their firewall, the present invention can be configured to allow such utilization for such an installation; with the service provider, or, as it were, the system supplier also giving the user special purchase instructions for the hardware and sub-component software requirements of such a configuration.

The invention described above can be seen to meet a key objective of the present invention—i.e., to provide a system and method for creating a commercial real estate “FRA lease comp” database and information exchange service. Users of this service will be able to directly upload into the service provider's databases their own “lease comp data.” Algorithms of the present invention then convert this information into various metrics, for example—an occupancy cost parameter or “standardized lease comp” value for a listed property, that serves to enable one to make rapid and easy “occupancy cost comparisons” of a participating brokerage firm's various leases. This information can then be utilized within a brokerage firm so as to provide a more informative view of the commercial real estate market pertaining to a particular geographic area.

The foregoing is considered as illustrative only of the principles of the present invention. Further, since numerous modifications and changes will readily occur to those skilled in the art, it is not desired to limit the invention to the exact construction and operation shown and described herein. For example, it is considered obvious that the method and system described herein can also be claimed as a computer program comprising a computer readable, non-transitory storage medium and instructions thereon for providing occupancy cost comparisons between a plurality of commercial leased properties by utilizing the method and systems described herein. Accordingly, all suitable modifications and equivalents may be resorted to, falling within the scope of the invention that is hereafter set forth in the claims to the invention.

1. A method, performed by a networked computing device, for providing service users with occupancy cost comparisons between a plurality of commercial leased properties, said method comprising the steps of:
defining an occupancy cost parameter for a leased property,
providing a database,
providing a spreadsheet adapted for each of said service users to use to input into said database the identifying property information and the specific lease terms required to compute said occupancy cost parameter for each of said leased properties to which a service user has been a principal in the leasing transaction of said leased property,
accepting into said database said identifying property information and the specific lease terms required to compute said occupancy cost parameter for each of said leased properties to which a service user has been a principal in the leasing transaction of said leased property,
utilizing said networked computing device, with said inputted specific lease terms information, to compute said occupancy cost parameter for each of said leased properties,
utilizing said computed occupancy cost parameters to create a fiduciary-responsibility-abiding (FRA) lease comp for each of said leased properties,
storing in said database said created FRA lease comp for each of said leased properties, and
wherein said database having has a configuration adapted to provide for the searching of said created FRA lease comps stored in said database by each of said service users.

2. The method as recited in claim 1, further comprising the step of:
analyzing said FRA lease comps stored in said database to make occupancy cost comparisons between said leased properties.

3. The method as recited in claim 1, further comprising the step of:
adapting further said spreadsheet for each of said service users to use to input into said database the identifying property information and the specific lease terms required to compute said occupancy cost parameter for a market property to which said inputting service user has not been a principal in the leasing transaction of said market property,
computing, utilizing said inputted specific lease terms information, said occupancy cost parameter for each of said market property,
utilizing said computed occupancy cost parameters to create a market comp for said market property,
storing in said database said created market comp for each of said market property, and
wherein said database has having a configuration adapted to provide for the searching of said created market comps stored in said database by each of said service users.

4. The method as recited in claim 2, further comprising the steps of:
adapting further said spreadsheet for each of said service users to use to input into said database the identifying property information and the specific lease terms required to compute said occupancy cost parameter for a market property to which said inputting service user has not been a principal in the leasing transaction of said market property,
computing, utilizing said inputted specific lease terms information, said occupancy cost parameter for each of said market property,
utilizing said computed occupancy cost parameters to create a market comp for said market property,
storing in said database said created market comp for each of said market property, and
wherein said database has having a configuration adapted to provide for the searching of said created market comps stored in said database by each of said service users.

5. The method as recited in claim 1 and expanded to include the function of storing and analyzing lease comp related information acquired throughout the life cycle of a property leasing transaction, said method further comprising the steps of:
providing a private database for each of said service users, and
adapting further said spreadsheet for each of said service users to use to input into said private database of said service user said lease comp related information acquired by said service user throughout the life cycle of a property leasing transaction of said service user.

6. The method as recited in claim 2 and expanded to include the function of storing and analyzing lease comp related information acquired throughout the life cycle of a property leasing transaction, said method further comprising the steps of:
providing a private database for each of said service users, and
adapting further said spreadsheet for each of said service users to use to input into said private database of said service user said lease comp related information acquired by said service user throughout the life cycle of a property leasing transaction of said service user.

7. The method as recited in claim 3 and expanded to include the function of storing and analyzing lease comp related information acquired throughout the life cycle of a property leasing transaction, said method further comprising the steps of:
providing a private database for each of said service users, and
adapting further said spreadsheet for each of said service users to use to input into said private database of said service user said lease comp related information acquired by said service user throughout the life cycle of a property leasing transaction of said service user.

8. The method as recited in claim 4 and expanded to include the function of storing and analyzing lease comp related information acquired throughout the life cycle of a property leasing transaction, said method further comprising the steps of:
providing a private database for each of said service users, and
adapting further said spreadsheet for each of said service users to use to input into said private database of said service user said lease comp related information acquired by said service user throughout the life cycle of a property leasing transaction of said service user.

9. The method as recited in claim 7, further comprising the step of:
analyzing said lease comp related information acquired by said service user throughout the life cycle of a property leasing transaction of said service user.

10. The method as recited in claim 8, further comprising the step of:
analyzing said lease comp related information acquired by said service user throughout the life cycle of a property leasing transaction of said service user.

11. A system for providing service users with occupancy cost comparisons between a plurality of commercial leased properties, said system comprising:
a defined occupancy cost parameter for a leased property,
a database,
a spreadsheet for each of said service users to use to input into said database the identifying property information and the specific lease terms required to compute said occupancy cost parameter for each of said leased properties to which a service user has been a principal in the leasing transaction of said leased property,
a networked computing device programmed to accept into said database said identifying property information and the specific lease terms,
wherein said computing device further programmed to utilize said inputted specific lease terms information to compute said occupancy cost parameter for each of said leased properties,
wherein said computing device further programmed to use said computed occupancy cost parameters to create a fiduciary-responsibility-abiding (FRA) lease comp for each of said leased properties,
wherein said created FRA lease comp for each of said leased properties being stored in said database, and
wherein said database has a configuration adapted to provide for the searching of said created FRA lease comps stored in said database by each of said service users.

12. The system as recited in claim 11, wherein:
said computing device further programmed to analyze said FRA lease comps stored in said database to make occupancy cost comparisons between said leased properties.

13. The system as recited in claim 11, wherein:
said spreadsheet further adapted for each of said service users to use to input into said database the identifying property information and the specific lease terms required to compute said occupancy cost parameter for a market property to which said inputting service user has not been a principal in the leasing transaction of said market property,
said computing device further programmed to utilize said inputted specific lease terms information to compute said occupancy cost parameter for each of said market property,
said computing device further programmed to use said computed occupancy cost parameters to create a market comp for said market property,
said created market comp for each of said market property being stored in said database, and
said database has a configuration adapted to provide for the searching of said created market comps stored in said database by each of said service users.

14. The system as recited in claim 12, wherein:
said spreadsheet further adapted for each of said service users to use to input into said database the identifying property information and the specific lease terms required to compute said occupancy cost parameter for a market property to which said inputting service user has not been a principal in the leasing transaction of said market property,
said computing device further programmed to utilize said inputted specific lease terms information to compute said occupancy cost parameter for said market property,
said computing device further programmed to use said computed occupancy cost parameters to create a market comp for said market property,
said created market comp for each of said market property being stored in said database, and
said database has a configuration adapted to provide for the searching of said created market comps stored in said database by each of said service users.

15. The system as recited in claim 11 whose function is expanded to include the storing and analyzing of said lease comp related information acquired throughout the life cycle of a property leasing transaction, said system further comprising:
a private database for each of said service users, and
wherein said spreadsheet further adapted for each of said service users to use to input into said private database of said service user said lease comp related information acquired by said service user throughout the life cycle of a property leasing transaction of said service user.

16. The system as recited in claim 12 whose function is expanded to include the storing and analyzing of said lease comp related information acquired throughout the life cycle of a property leasing transaction, said system further comprising:
a private database for each of said service users, and
wherein said spreadsheet further adapted for each of said service users to use to input into said private database of said service user said lease comp related information acquired by said service user throughout the life cycle of a property leasing transaction of said service user.

17. The system as recited in claim 13 whose function is expanded to include the storing and analyzing of said lease comp related information acquired throughout the life cycle of a property leasing transaction, said system further comprising:
a private database for each of said service users, and
wherein said spreadsheet further adapted for each of said service users to use to input into said private database of said service user said lease comp related information acquired by said service user throughout the life cycle of a property leasing transaction of said service user.

18. The system as recited in claim 14 whose function is expanded to include the storing and analyzing of said lease comp related information acquired throughout the life cycle of a property leasing transaction, said system further comprising:
a private database for each of said service users, and
wherein said spreadsheet further adapted for each of said service users to use to input into said private database of said service user said lease comp related information acquired by said service user throughout the life cycle of a property leasing transaction of said service user.

19. The system as recited in claim 18, wherein:
said computing device further programmed to analyze said lease comp related information acquired by said service user throughout the life cycle of a property leasing transaction of said service user.

20. A computer program product for use in conjunction with a computer system including a processor and a memory storage device, the computer program product comprising a computer readable, non-transitory storage medium and instructions thereon for providing service users with occupancy cost comparisons between a plurality of commercial leased properties, said instructions comprising the steps of:
defining an occupancy cost parameter for a leased property,
creating a database on said memory storage device,
creating a spreadsheet for each of said service users to use to input into said database the identifying property information and the specific lease terms required to compute said occupancy cost parameter for each of said leased properties to which a service user has been a principal in the leasing transaction of said leased property,
accepting into said database said identifying property information and the specific lease terms required to compute said occupancy cost parameter for each of said leased properties to which a service user has been a principal in the leasing transaction of said leased property,
directing said processor to use said inputted specific lease terms information to compute said occupancy cost parameter for each of said leased properties,
directing said processor to use said computed occupancy cost parameters to create a fiduciary-responsibility-abiding (FRA) lease comp for each of said leased properties,
storing in said database said created FRA lease comp for each of said leased properties, and
configuring said database to provide for the searching of said created FRA lease comps stored in said database by each of said service users.
